(19) United States
(12) Patent Application Publication
(10) Pub. No.: US 2003/0023978 A1
(43) Pub. Date: Jan. 30, 2003

(54) Satellite television system

(76) Inventor: Brian David Bajgrowicz, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/200,095

(22) Filed: Jul. 19, 2002

Related U.S. Application Data
(60) Provisional application No. 60/307,833, filed on Jul. 25, 2001.

(51) Int. Cl. H04H 1/00; H04N 7/20

(52) U.S. Cl. 725/68; 725/63; 455/3.02

(57) ABSTRACT

A satellite television system includes a satellite television receiver and method of operation adjusts itself to properly receive satellite television signals that have been determined to exist outside of an expected frequency spectrum location. Received satellite television signals include data regarding location of a particular television signal within a predetermined frequency spectrum location within a frequency band. Particularly, each satellite television signal includes data regarding its location within a predetermined frequency spectrum location within a frequency band. The system and method can determine whether received satellite television signals have been processed by a high-side injected local oscillator stacker. In one form, the satellite television system and method detects spectral inversion of the received satellite television signal within a frequency band.

This U.S. non-provisional patent application claims the benefit of and/or priority to U.S. provisional patent application serial No. 60/307,833 filed Jul. 25, 2001 entitled “Detection of High-Side Injected Local Oscillator Transponder Stacker.”

### BACKGROUND

1. Field of the Invention

The present invention relates to satellite television systems and, more particularly, to operation of a satellite television signal receiver in response to frequency plans utilized for dissemination of the received satellite television signals.

2. Background Information

Satellite programmers broadcast, or uplink, signals to a satellite from which they either own or lease channel space. The signals are often scrambled, or encrypted, to prevent unauthorized reception before they are retransmitted to a home antenna. The uplinked signals are received by a transponder located on the satellite, a device that receives the signals and transmits them back to the earth after converting them to a frequency that can be received by a ground-based antenna. Typically, there are 24 to 32 transponders on each satellite. In order to minimize interference between the transponder signals, the transponder signals are transmitted with alternately polarized antennas. Each satellite occupies a particular location in orbit, and operates within a particular frequency band or range assigned by the FCC. A satellite television system typically transmits a plurality of television signals constituting television channels of programming via the transponders. Each transponder provides a television signal on a particular frequency within the frequency band.

The signals received at the satellite from a ground-based antenna are extremely weak in amplitude—much less than one watt. As a result, they must employ amplifiers that boost the signals to a level that can successfully be processed and retransmitted to the earth. After traveling approximately 22,000 miles from the satellite to a ground-based antenna, the signals are again very weak and must be amplified. A satellite dish antenna is used to focus the received signals to a low-noise block (LNB) converter. The LNB amplifies the signals and block down converts the amplified signals to a lower frequency/frequency range. The lower the transmitting power of the satellite, the larger the antenna required to focus/collect the signals. A C-Band satellite, with power ranging between approximately 10 and 17 watts per transponder, typically has an antenna between 5 and 10 feet in diameter, whereas a high-powered Ku-Band satellite, with a power range of approximately 100 to 200 watts per transponder, only requires an antenna 18 inches in diameter. The signals from the antenna system (antenna and LNB) are fed to a satellite television signal receiver (satellite television receiver) such as an integrated receiver/decoder (IRD), which converts the television signals from the LNB into a form that can be tuned by a TV set. Every IRD contains a unique address number, which is activated by a satellite programmer to allow it to receive subscription services. In addition, the IRDs modem port is connected to a telephone line, in order to access pay-per-view ordering services and transmit other data. A single IRD can supply one channel choice to one or more TV sets. In order to view two different programs at the same time on two different TV sets, two IRDs are required—one for each TV, and the antenna system must be a dual-LNB type (i.e. provides two outputs). A satellite television system thus typically transmits in the Ku band while the LNB down converts the Ku band signals to L-band signals.

A stacker is a device that takes two incoming sets (polarizations) of transponders in the same frequency band and puts one in the same frequency band and the other in a frequency band immediately above. Two polarization schemes are typically used for the satellite-transmitted television signals. One polarization scheme is left-hand circular polarization—LHCP/right-hand circular polarization—RHCP. Another polarization scheme is horizontal polarization/vertical polarization. One scheme or the other (or another type of polarization scheme) is used for the signal being transmitted from the satellite antenna to the LNB at the receiving antenna. The satellite television receiving system must be able to receive both polarizations (sets).

As an example, a satellite television system may have its down converted transponders in the L-band between 950-1450 MHz. There can exist two different polarizations in the signal being transmitted from the satellite to the LNB at the receiving antenna. The LNB down converts the signal to an L-band signal in the 950 to 1450 MHz range. Only one polarization can be selected at a time in this band due to the functionality of the LNB (i.e. a block converter). The present example assumes the RHCP/LHCP polarization scheme. The stacker takes the LHCP signal and up-converts the LHCP signal to the band 1450-2150 MHz and combines it with the RHCP signal in the 950-1450 MHz band. The combined signal is then provided on a single output. This provides all available transponders on a single output for the IRD.

One type of stacker utilizes a local oscillator (LO) frequency that is above the up-converted frequency band in order to accomplish stacking. This is known as high-side injection (high-side injected). This results in an inversion of the up-converted set of transponders (i.e. one set of polarized signals). With such inversion, the LHCP or horizontally polarized transponder that existed at the low end of the 950-1450 MHz band is now at the upper side of the 1450-2150 MHz band, while the LHCP or horizontally polarized transponder that was at the upper end of the 950-1450 MHz band is now at the lower end of the 1450-2150 MHz band. It is evident from the above, that there are various frequency plans (i.e. satellite television signal frequency distribution or dissemination plans).

In view of the various frequency plans that may be used in a satellite television signal system, the satellite television signal receiver needs to know the type of frequency plan utilized for dissemination of the received satellite television signals in order to appropriately process the satellite television signals.

It would thus be desirable to have a satellite television signal system and/or receiver that can recognize various satellite television signal frequency plans.

It would be thus further desirable to have a satellite television signal system and/or receiver that recognize various satellite television signal frequency plans and adjust itself to appropriately receive and/or process the received satellite television signals.

It would thus be even further desirable to have a satellite television signal system and/or receiver that determines if an incoming satellite television signal has been processed utilizing a high-side injected local oscillator stacker.

It would thus be also desirable to have a satellite television signal system and/or receiver that detects an inverted-stacking frequency plan and utilize the information to process all of the received satellite television signals without having a user input setup information regarding the satellite television signal frequency plan/configuration.

### SUMMARY

In accordance with an aspect of the invention, a satellite television signal receiver comprises means for receiving satellite television signals, the satellite television signals including data indicating expected location of a particular satellite television signal within a frequency band of a frequency spectrum, means for determining whether actual location data of the particular satellite television signal correlates to the expected location data of the particular satellite television signal, and means for adjusting the satellite television signal receiver to properly receive the satellite television signals when it is determined that actual position data of the particular satellite television signal is outside correlation to the expected location data.

In accordance with another aspect of the invention, in a satellite television signal receiver, a method of operation comprises receiving satellite television signals, the satellite television signals including data indicating expected location of a particular satellite television signal within a frequency band of a frequency spectrum, determining whether actual location data of the particular satellite television signal correlates to the expected location data of the particular satellite television signal, and adjusting the satellite television signal receiver to properly receive the satellite television signals when it is determined that actual position data of the particular satellite television signal is outside correlation to the expected location data.

In accordance with another aspect of the invention, a satellite television signal receiver comprises a tuner for receiving satellite television signals, the satellite television signals including data indicating expected location of a particular satellite television signal within a frequency band of a frequency spectrum, determination logic operative to determine whether actual location data of the particular satellite television signal correlates to the expected location data of the particular satellite television signal, and adjustment logic operative to adjust the satellite television signal receiver to properly receive the satellite television signals when it is determined that actual position data of the particular satellite television signal is outside correlation to the expected location data.

### BRIEF DESCRIPTION OF THE DRAWINGS

The above-mentioned and other features and advantages of this invention, and the manner of attaining them, will become more apparent and the invention will be better understood by reference to the following description of embodiment(s) of the invention taken in conjunction with the accompanying drawings, wherein:

FIG. 1 is a representation of an exemplary satellite television system in which the subject invention may be utilized;

FIG. 2 is a block diagram of one form of exemplary signal conditioning circuitry for the exemplary satellite television system of FIG. 1;

FIG. 3 is a block diagram of another form of exemplary signal conditioning circuitry for the exemplary satellite television system of FIG. 1;

FIG. 4 is a representation of a frequency band in which the satellite television signals are down converted;

FIG. 5 is a block diagram of an exemplary form of a satellite television receiving system/receiver in accordance with the principles of the subject invention;

FIG. 6 is a block diagram of another exemplary form of a satellite television receiving system/receiver in accordance with the principles of the subject invention;

FIG. 7 is a representation of an exemplary unstacked satellite television signal frequency distribution plan;

FIG. 8 is a representation of an exemplary stacked satellite television signal frequency distribution plan;

FIG. 9 is a representation of an exemplary stacked-inverted satellite television signal frequency distribution plan;

FIG. 10 is a flowchart of an exemplary manner of operation of the subject invention; and

FIG. 11 is a flowchart of another exemplary manner of operation of the subject invention.

Corresponding reference characters indicate corresponding parts throughout the several views.

### DESCRIPTION OF THE PREFERRED EMBODIMENT(S)

This application discloses a satellite television signal receiving system and method of operation that adjusts operation thereof in response to frequency plan utilized for distribution and/or dissemination of the received satellite television signals. Particularly, the system determines if a received satellite television signal is situated at an expected location within a frequency band.

According to an exemplary embodiment, the system determines whether a received satellite television signal has been processed by a high-side injected local oscillator stacker. In one form, the system and method detect spectral inversion of the received satellite television signal.

More particularly, the satellite television signal receiving system and method of operation that detect whether received satellite transponder signals have been processed by a high-side injected local oscillator stacker or a stacked LNB utilizing a high-side injected local oscillator. A high-side local oscillator inverts satellite transponder signals in a predetermined frequency band. This allows the satellite television receiver to appropriately process and/or rearrange the satellite transponder signals in the predetermined frequency band.

In one form, the satellite television signal receiving system includes a tuner for receiving satellite television signals, wherein the satellite television signals include data indicating expected location of a particular satellite television signal within a frequency band of a frequency spectrum. The system also includes determination logic operative to determine whether actual location data of the particular satellite television signal correlates to the expected location data of the particular satellite television signal. The system further includes adjustment logic operative to adjust the satellite television system to properly receive the satellite television signals when it is determined that actual position data of the particular satellite television signal is outside correlation to the expected location data.

In another form, the method includes the steps of (a) receiving satellite television signals, the satellite television signals including data indicating expected location of a particular satellite television signal within a frequency band of a frequency spectrum; (b) determining whether actual location data of the particular satellite television signal correlates to the expected location data of the particular satellite television signal; and (c) adjusting the satellite television system to properly receive the satellite television signals when actual position data of the particular satellite television signal is outside correlation to the expected location data.

In yet another form, the satellite television signal receiving system includes means for receiving satellite television signals, the satellite television signals including data indicating expected location of a particular satellite television signal within a frequency band of a frequency spectrum, means for determining whether actual location data of the particular satellite television signal correlates to the expected location data of the particular satellite television signal, and means for adjusting the satellite television system to properly receive the satellite television signals when it is determined that actual position data of the particular satellite television signal is outside correlation to the expected location data.

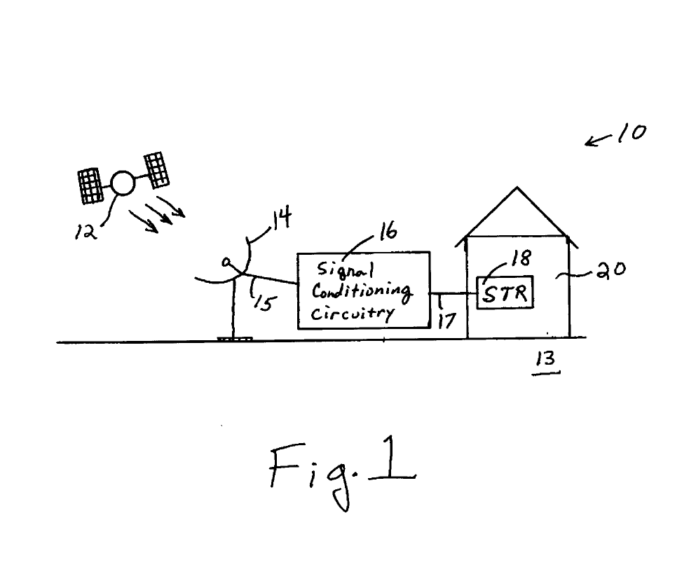

Referring now to the drawings and, more particularly to FIG. 1, there is depicted a simplified pictorial representation of a satellite television signal receiving system (hereinafter “satellite television system”) generally designated 10. Satellite television system 10 is representative of any type of satellite television system such as a direct broadcast system (DBS), two-way (interactive) satellite television system and the like. While the present invention will be described herein in connection with a DBS system, it should be appreciated that other satellite television and/or entertainment system may utilize the subject invention.

Satellite television system 10 includes satellite 12 in geosynchronous orbit, low earth orbit (LEO), or the like. Satellite 12 has from one to a plurality of transponders. Typically, satellite 12 has twenty-four (24) to thirty-two (32) transponders. While the present invention will be described in connection with satellite 12 that has thirty-two (32) transponders, it should be appreciated that the subject invention may be utilized with satellites having from one to a plurality of any number of transponders. Thus, satellite 12 is representative of any such satellite.

Satellite 12 provides television signals from the transponders (i.e. transponder signals) represented by the arrows emanating from the satellite to the earth (ground) 13. In the present example, satellite 12 has thirty-two (32) transponders. The television signals from satellite 12 may be in any frequency band, but is typically in the Ku band. Additionally, satellite 12 has two antennas, one for each desired polarization (polarization scheme). In the present example, half or sixteen (16) of the transponders are coupled to one antenna, while the other half or sixteen (16) of the transponders are coupled to the other antenna. Antenna 14 is provided on the earth 13 that is operative, configured and/or adapted to receive the television signals from satellite 12. Particularly, antenna 14 is configured, operative and/or adapted to receive the variously polarized satellite television signals of varied frequencies.

Antenna 14 is shown as a dish type antenna and may be an eighteen inch (18″) dish type antenna for receiving Ku band satellite television signals. Antenna 14 may, however, be another type of antenna depending on the received wattage and/or the frequency of the satellite television signals. Particularly, in the present example, antenna 14 is operative, configured and/or adapted to receive the thirty-two (32) transponder signals. The thirty-two (32) transponder signals are preferably two sets of sixteen (16) transponder signals each set of a particular polarization.

Antenna 14 is coupled to and/or in communication with signal conditioning circuitry (circuitry and/or logic) 16 via signal transmitting conductor 15. Signal conditioning circuitry 16 is typically outside and proximate antenna 14. Signal conditioning circuitry 16 is operative, configured and/or adapted to down convert, amplify, and stack the incoming satellite television signals. The processed satellite television signals, in the present example, are processed by signal conditioning circuitry 16 such that the satellite television signals being output are in the L-band.

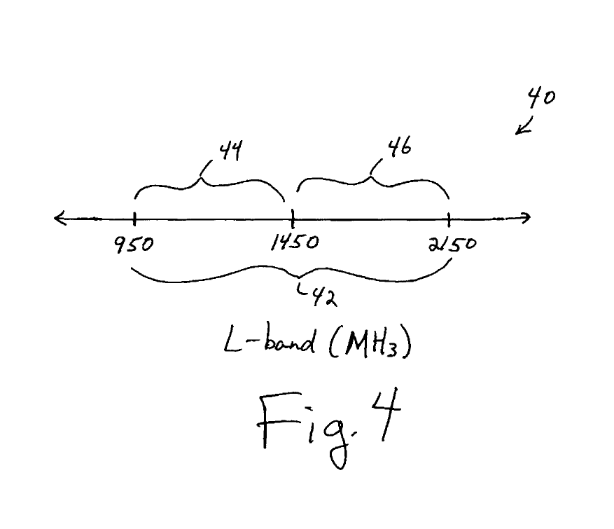

Referring to FIG. 4, there is depicted a representation 40 of a portion of the electromagnetic frequency spectrum in the megahertz (MHz) range. The frequency band or range between 950 MHz and 2150 MHz is part of the L-band 42. This portion of the L-band 42 may be subdivided into a lower frequency band or range 44, namely the 950 MHz to 1450 MHz band, and an upper frequency band or range 46 namely the 1450 MHz to 2150 MHz band.

Satellite television system 10 also includes satellite television signal receiver 18. Satellite television signal receiver 18 may take the name and/or form of a satellite receiver, integrated receiver/decoder (IRD), satellite signal receiver, satellite receiver/receiving means, set-top box, and/or the like. Satellite television receiver (STR) 18 is typically indoors (i.e. within a structure such as a house 20) and configured, operative, and/or adapted to receive the down converted satellite television signals from signal conditioning circuitry 16 via signal transmitting conductor 17. Signal transmitting conductor 17 may be a coaxial cable or the like. STR 18 is operative, configured and/or adapted to receive the conditioned or processed satellite television signals from signal conditioning circuitry 16, and provide further processing thereof as described herein.

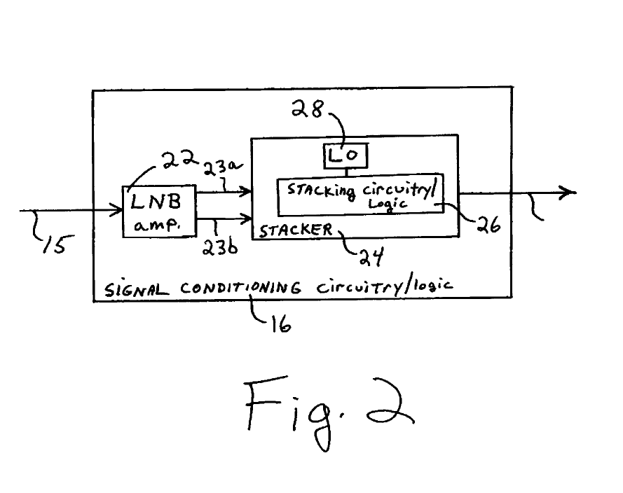

Signal conditioning circuitry 16 is typically one of two configurations. Referring to FIG. 2, there is depicted a block diagram of one such configuration. Signal conditioning circuitry 16 includes LNB 22 that receives the satellite television signals via signal transmitting conductor 15 and outputs a television signal in the L-band via the single signal transmitting conductor 17. LNB 22 has frequency down conversion circuitry/logic that block down converts the incoming satellite television signals. In the present example, the incoming satellite television signals are in the Ku band and are amplified by amplifier circuitry/logic of LNB 22 and then block down converted into L-band 42, particularly lower band 44 as illustrated in FIG. 4.

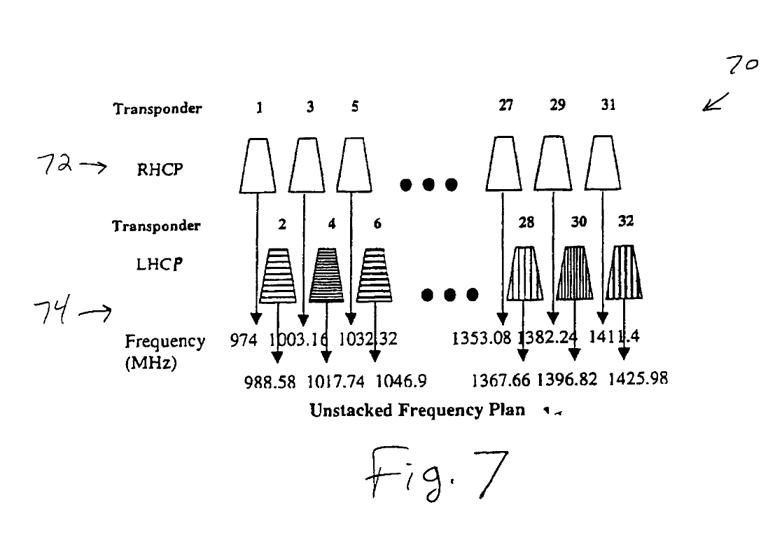

FIG. 7 provides an example of an unstacked frequency plan for a thirty-two (32) transponder satellite television signal system that is generally designated 70 as may be outputted by LNB 22. Unstacked frequency plan 70 has thirty-two transponders designated by a respective trapezoid 1-32. Transponders 1-32 are subdivided into odd transponders 1, 3, 5 . . . 31, generally designated 72, and even transponders 2, 4, 6 . . . 32, generally designated 74. Of the odd and even transponders, odd transponders 1, 3, 5 . . . 31 are right hand circular polarized (RHCP), while even transponders 2, 4, 6 . . . 32 are left hand circular polarized (LHCP). Shown below each transponder is the expected down converted frequency. In this example, down converted transponders 1-32 are in the lower portion of this section of L-band (950-1450 MHz). It should be appreciated that the various attributes of transponders 1-32 may be interchanged typically without consequence in unstacked frequency plan 70. Further, it should be appreciated that unstacked frequency plan 70 of FIG. 7 is exemplary. As such, other unstacked frequency plans may be utilized that vary the number, frequency and/or other attributes and/or characteristics of the transponders.

LNB 22 processes the satellite television signals by dividing transponders 1-32 into a set according to an attribute or characteristic, such as polarization in the present example. RHCP transponders 72 and LHCP transponders 74 are provided to stacker 24 via separate conductors or paths 23a and 23b. Stacker 24 separately receives RHCP transponders 72 and LHCP transponders 74. Stacker 24 includes stacking circuitry/logic 26 that is controlled, at least in part, by local oscillator (LO) 28. Local oscillator 28 provides an oscillator signal at a particular frequency.

Stacker 24 is configured, operative and/or adapted to take one set of transponders according to an attribute or characteristic thereof, such as polarization in the present example, and shift or up convert the one set of transponders to a frequency band or range that is greater than the frequency band of the down converted television signals.

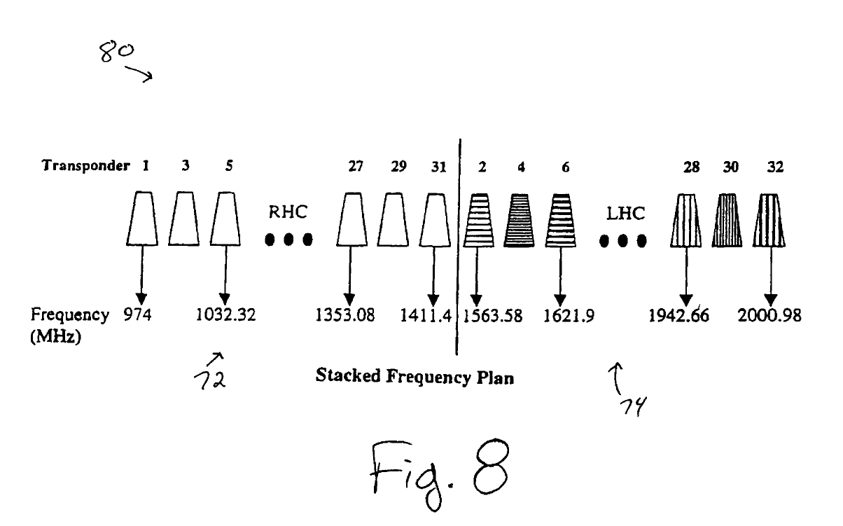

Stacked frequency plan 80 is illustrated in FIG. 8 and reference is now made thereto. Stacked frequency plan 80 takes one set of transponders, e.g. RHCP transponders 72, and keeps them at their assigned frequency in lower portion 44 of L-band 42. Stacked frequency plan 80 takes the other set of transponders, e.g. LHCP transponders 74, and up-converts them to an upper frequency portion or range 46 (see FIG. 4) of L-band 42. As shown in FIG. 8, even transponders 2, 4, 6 . . . 32 each have an assigned frequency that is above lower band 72. The transponder signals for even transponders 2, 4, 6 . . . 32 retain their transponder data after up converted according to stacked frequency plan 80. It should be noted that stacked frequency plan 80 is produced by a stacker or a stacked LNB having a local oscillator which has a frequency of oscillation that is less than and/or equal to the down converted frequency band of the transponders. (i.e. a stacker that is not “high-side injected”).

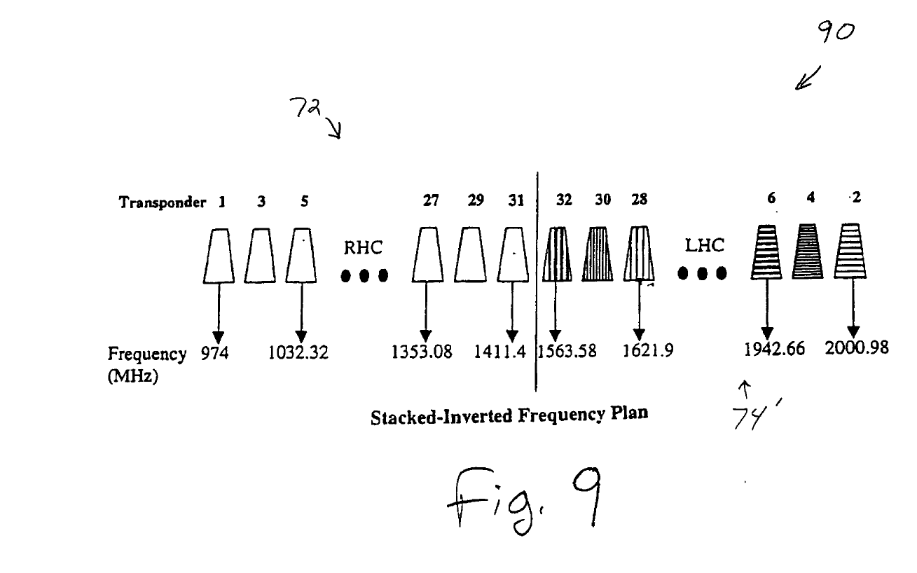

Local oscillator 28 of stacker 24, however, has a frequency that is greater than the frequency band of the down converted satellite television signals. The oscillator signal from local oscillator 28 is provided to stacking circuitry/logic 26 to process (i.e. stack) the down converted and amplified satellite television signals. Stacker 24 outputs the processed satellite television signals on coaxial cable (conductor) 17. Because the frequency of the local oscillator is greater than the frequency of the down converted satellite television signals, upper transponders 74′ are inverted as represented in FIG. 9. Stacker 24 is thus high-side injected and/or known as a high-side injected stacker. The subject invention in one form detects whether the signals from signal conditioning circuitry 16 have been processed by a high-side injected stacker or by a stacked LNB utilizing a high side injected LO. In another form, the subject invention detects a spectral inversion of the band of transponders. Such spectral inversion denotes high-side injection.

In FIG. 9, a stacked-inverted frequency plan generally designated 90 is shown such as that which results from a high-side injected stacker such as high-side injected stacker 24. One set of transponders is within low band 44 while another set of transponders is within upper band 46. As with the other frequency plans, the lowest to highest transponder number is associated with the expected lowest to highest frequency within the given frequency band. However, rather than the transponders (frequencies) being simply shifted upwardly during up conversion, the high-side injected local oscillator inverts the normal lowest to highest transponder number to the expected lowest to highest transponder a highest to lowest transponder number to actual lowest to highest transponder frequency. It should be appreciated that the transponder numbers and frequencies are arbitrary. Therefore, other stacked-inverted frequency plans are contemplated.

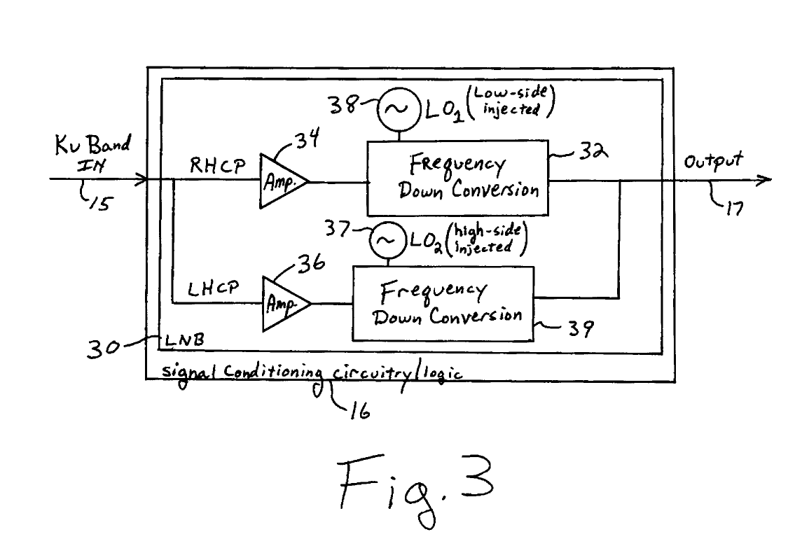

Referring now to FIG. 3, there is depicted a block diagram of another such configuration of signal conditioning circuitry 16. In this example, signal conditioning circuitry 16 includes integrated LNB 30 that receives the satellite television signals via signal transmitting conductor 15 and outputs a television signal in the L-band via single signal transmitting conductor 17. LNB 30 processes the satellite television signals by dividing transponders 1-32 into sets according to an attribute or characteristic, such as polarization in the present example. In the present example, both polarizations (LHCP and RHCP) of the incoming satellite television signals are in the Ku band and are amplified by respective amplifier circuitry/logic 34 for the RHCP and amplifier circuitry/logic 36 for the LHCP. The RHCP transponders are then block down converted by frequency down conversion circuitry/logic 32 into L-band 42, particularly lower band 44 utilizing low-side injected local oscillator 38. The LHCP transponders are block down converted by frequency down conversion circuitry/logic 39 into L-band 42, particularly upper band 46 utilizing high-side injected local oscillator 37. The choice of the particular frequency for this local oscillator 37 will perform the stacking of the signals. Because the frequency of local oscillator 37 is greater than the frequency of the incoming satellite television signals, the LHCP transponders are inverted (74′) as represented in FIG. 9. The stacked LNB is thus high-side injected and/or known as a high-side injected stacked LNB. Both the block down converted LHCP and RHCP signals are provided on a single output 17.

Satellite 12 transmits television signal data/information along with the television signal for each transponder. The television signal data may include, without being limiting, the transponder number, the original transponder frequency, and/or the expected down converted frequency. The transponder data is maintained by signal conditioning circuitry 16. Therefore, the transponder data is provided to satellite television signal receiver 18.

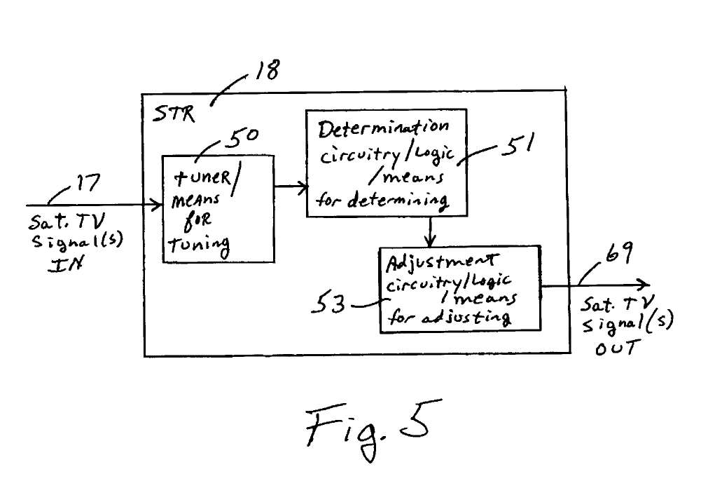

Referring now to FIG. 5, there is depicted a block diagram of an exemplary satellite television signal receiving system/receiver embodied in STR 18. In this embodiment, STR 18 includes tuner (means for tuning) 50 that is operative to receive one or more satellite (transponder) signals from input 17. Tuner 50 is coupled to determination circuitry/logic (means for determining) 51. Tuner 50 may also obtain location data embedded in the satellite television signal. The location data provides, at a minimum, expected transponder data and/or frequency data for at least one of the satellite television signals and preferably for all of the satellite television signals. Preferably, the location data is embedded in each respective satellite television signal. Determination circuitry/logic 51 is operative to determine whether actual location of a particular satellite television signal in a frequency band correlates to the expected location data of the particular satellite television signal. Determination circuitry/logic 51 is coupled to adjustment circuitry/logic (means for adjusting) 53. Adjustment circuitry/logic 53 is operative to set the mode of operation and/or adjust the processing of STR 18 to appropriately receive the satellite television signals according the frequency plan of the satellite television signals as received by STR 18. The satellite television signals are then outputted via output 69.

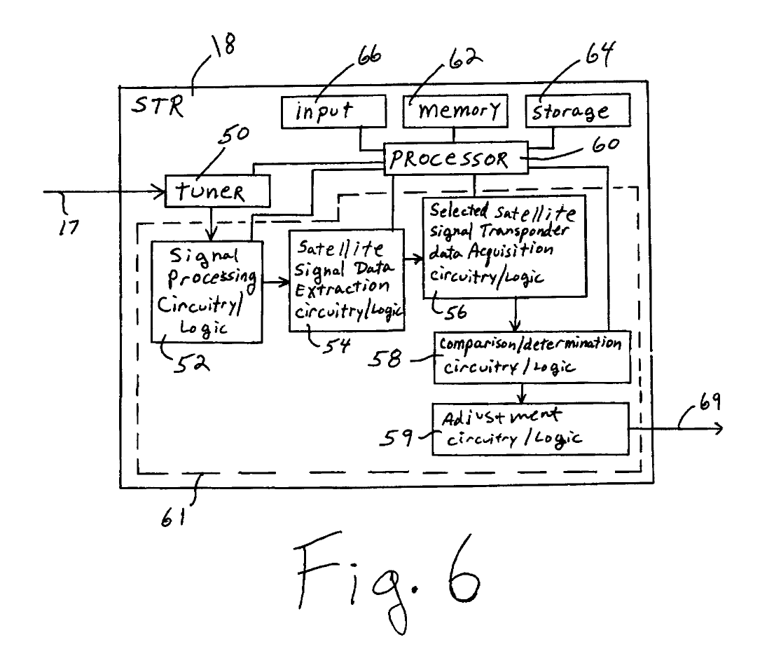

Referring now to FIG. 6, there is depicted a block diagram of another exemplary satellite television receiver (STR) 18. STR 18 may be deemed a satellite television signal receiver, a satellite television signal receiving system, or the like. STR 18 includes a processor 60 that may be coupled to memory 62, a data storage device 64, and a user input device 66. Processor 60 is operative to execute program instructions from memory 62 that controls the various components of STR 18 as described herein. As such, processor 60 is preferably coupled to every component. It should also be appreciated that the functionality described herein may be implemented by circuitry/logic, program instructions, and/or a combination of circuitry/logic and program instructions. Particularly, where the term circuitry/logic is used, electronic circuitry, logic (programming instructions), and/or a combination of electronic circuitry and programming instructions may be used.

STR 18 is operative, configured and/or adapted to receive the satellite television (transponder) signals from signal conditioning circuitry/logic 16. Particularly, STR 18 is operative to further process the satellite television signals from signal conditioning circuitry/logic 16. Tuner or tuning circuitry/logic 50 of STR 18 is operative, configured and/or adapted to receive the transponder signals and tune or select a particular transponder signal particularly a transponder signal from the upper frequency band of the plurality of transponders in a frequency band subdivided into a lower frequency band and an upper frequency band. The tuning by tuner 50 to acquire a transponder signal in the upper frequency band may be a search of the upper frequency band that starts at a lowermost frequency of the upper frequency band and ends at the uppermost frequency or vice versa.

Signal processing circuitry/logic 52 is coupled to tuner 50 and is operative, configured and/or adapted to receive the selected transponder signal from tuner 50. Signal processing circuitry/logic 52 is further operative, configured and/or adapted to determine, among other functions, if the selected transponder signal is proper for the particular satellite system. Particularly, signal processing circuitry/logic 52 looks at data rate, the forward error correction scheme, symbol rate and the like, for such determination. Processing continues if the selected transponder signal has been determined to be proper.

STR 18 also includes transponder signal data extraction circuitry/logic 54 that is coupled to signal processing circuitry/logic 52. Transponder signal data extraction circuitry/logic 54 is operative, configured and/or adapted to extract or obtain transponder data from the transponder signal. The transponder data includes, but is not limited to, expected transponder number and expected transponder down converted frequency. The expected transponder number is the number of the transponder as received from satellite 12. The expected transponder frequency is the expected frequency of the transponder after being down converted without being stacked.

STR 18 further includes selected transponder signal transponder data acquisition circuitry/logic 56 that is coupled to transponder signal data extraction circuitry/logic 54. Selected transponder signal transponder data acquisition circuitry/logic 56 is configured, operative and/or adapted to obtain transponder data from the selected transponder signal regarding its actual transponder number and its actual transponder frequency. Stated another way, selected transponder signal transponder data acquisition circuitry/logic 56 obtains the actual down converted frequency of the selected transponder signal and the actual positional number of the transponder signal.

STR 18 further includes comparison/determination circuitry/logic 58 that is coupled to selected transponder signal transponder data acquisition circuitry/logic 56. Comparison/determination circuitry/logic 58 is operative, configured, and/or adapted to compare the expected transponder data with the actual transponder data and determine from the comparison the type of frequency plan used and/or whether the transponder signals were processed by a high-side injected stacker prior or previous to receipt by STR 18. Stated another way, comparison/determination circuitry/logic 58 determines if the transponder signals in the upper frequency band are inverted. Inversion indicates a high-side injected stacker has processed the transponder signals. Adjustment circuitry/logic 59 is responsive to the determination or correlation between the expected satellite/transponder location and the actual satellite/ transponder location to properly receive the satellite television signals. Output 69 provides the selected transponder signal.

Using the frequency plan described in FIGS. 7-9, if the acquired transponder signal has a transponder number that makes equation [1] true, it is known that the upper band of transponder signals have been inverted and thus have been processed by a high-side injected stacker.

Actual Transponder Number=34−Expected Transponder Number [1]

For example, if the actual transponder number extracted by the transponder signal data extraction circuitry/logic 54 is 32, and the expected transponder number as obtained by the selected transponder signal transponder data acquisition circuitry/logic 58 is 2, then equation [1] is true (i.e. 32=34−2).

Using the frequency plan described in FIGS. 7-9, if the acquired transponder signal has a frequency that makes equations [2] or [3] true, it is known that the upper band of transponder signals have been inverted and thus have been processed by a high-side injected stacker.

Frequency of Transponder from data (expected) in MHz=2975−Frequency where Transponder is found (actual) in MHz [2]

Frequency where Transponder is found (actual) in MHz=2975+575 Frequency of Transponder from data (expected) in MHz [3]

It should be appreciated that different frequency plans (i.e. frequency bands and transponder numbers) may require the above equations to change in accordance with the particular system. The data can be obtained from a transponder and the equations modified accordingly.

It should be further appreciated that the various circuitry/logic of FIG. 6 generally designated 61, and described herein, may be totally or partially implemented via program instructions (i.e. software) and executed by processor 60. Such program instructions may be stored in storage 64, loaded into memory 62, and executed by processor 60. User input 66 may be provided to processor 60 as necessary and/or appropriate. The program instructions may be stored in memory 62 that may constitute EEPROM or the like, then executed by processor 60. Various permutations are contemplated for storing and/or implementing the program instructions.

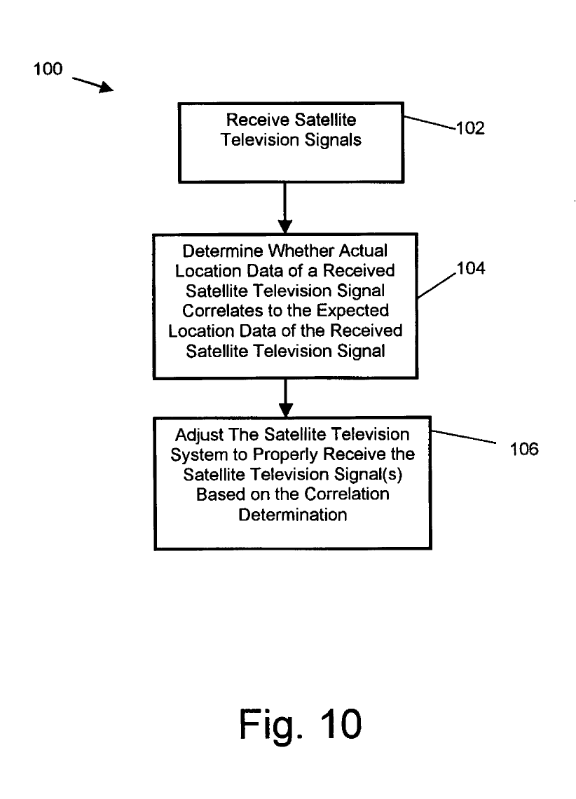

Referring now to FIG. 10, there is depicted a flowchart, generally designated 100, setting forth an exemplary manner of operation of the subject invention. In step 102, satellite television signals are received. Typically, multiple satellite television signals are received. Particularly, tuner 50 receives the satellite television signal(s). Location data for a particular satellite television signal is also received and, preferably, location data for each satellite television signal is received along with the satellite television signals. The locations data, among other data, includes expected location of the satellite television signal. Thereafter, in step 104, it is determined whether actual location data of a particular received satellite television signal correlates to the expected location data of the received satellite television signal. In this manner, the type of utilized frequency plan is ascertained. In step 106, the satellite television system is adjusted according to the correlation determination step (104) in order for the system to properly receive and/or process the satellite television signals.

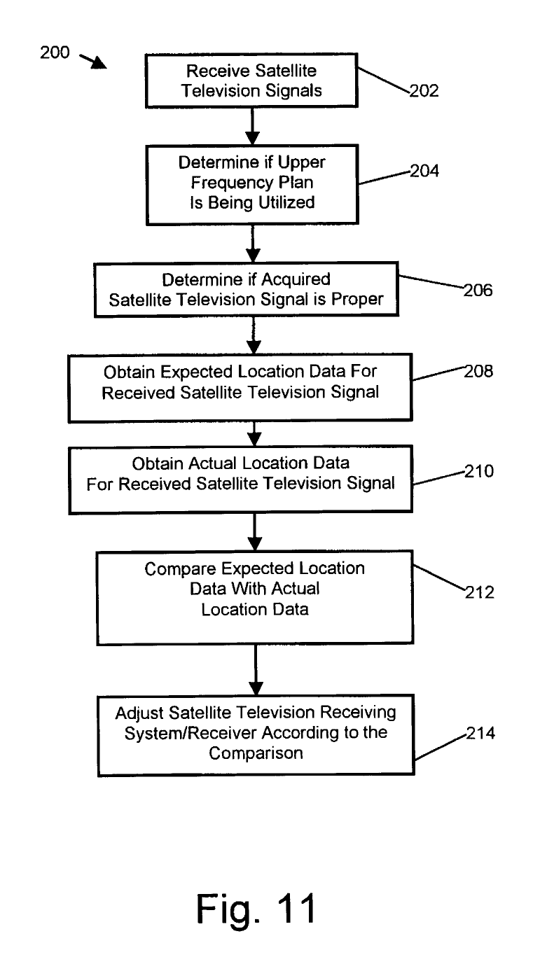

Referring now to FIG. 11, there is depicted a flowchart, generally designated 200, setting forth another exemplary manner of operation of the subject invention. It should be appreciated that the exemplary manner of operation of the subject invention shown in FIG. 11 may be an extension of and/or a particular case of the exemplary manner of operation of the subject invention shown in FIG. 10. As well, it should be appreciated that each step of operation of FIG. 11 may not be necessary to implement the subject invention.

In step 202, satellite television signal receiver 18 receives satellite television signals (i.e. transponder signals) from a satellite, typically from an LNB or LNB/stacker. Satellite television signal receiver 18, in step 204, determines if an upper frequency plan is being utilized. This may be accomplished by acquiring or attempting to acquire a satellite or transponder signal in an upper frequency band. Acquisition of a satellite signal in the upper frequency band typically starts with trying to acquire a satellite signal from a lower end of the upper frequency band to the upper end of the upper frequency band, but can be accomplished in reverse. As well, a satellite signal may be acquired through random selection of a frequency in the upper frequency band.

In step 206, it is determined if the acquired satellite signal is proper. The satellite signal is proper if the satellite signal includes the appropriate characteristics for the particular satellite system (i.e. the right data rate, forward error correction scheme, symbol rate, etc.). Once it has been determined that the selected satellite signal is proper, in step 208, expected data is obtained from the acquired satellite signal. The expected satellite data includes, but is not limited to, expected transponder number within the satellite television system scheme, and expected transponder frequency after down conversion. In step 210, actual satellite data is obtained. Actual satellite data includes, but is not limited to, actual satellite number due to its position in the upper frequency band, and actual down converted frequency of the transponder.

In step 212, the expected satellite data is compared to the actual satellite data. In step 214, the satellite television receiving system/receiver is adjusted according to the comparison in the previous step 212. This allows the system to determine the frequency plan or whether the transponder signals have been processed by a high-side injected stacker previous or prior to receipt by the satellite television receiver. This may be accomplished by determining if the transponder signals in the upper frequency band are inverted. Such inversion may be ascertained by the comparison.

It should be appreciated that the above flowchart describes a manner of operation that includes steps which may or may not be necessary for the core determination of whether a high-side injected stacker has processed the satellite television signals, and/or whether an upper frequency band of transponder signals are inverted.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

What is claimed is:

1. In a satellite television signal receiver, a method of operation comprising:
receiving satellite television signals, said satellite television signals including data indicating expected location of a particular satellite television signal within a frequency band of a frequency spectrum;
determining whether actual location data of said particular satellite television signal correlates to said expected location data of said particular satellite television signal; and
adjusting the satellite television signal receiver to properly receive said satellite television signals when it is determined that actual position data of said particular satellite television signal is outside correlation to said expected location data.

2. The method of claim 1, wherein the step of determining whether actual location data of said particular satellite television signal correlates to said expected location data of said particular satellite television signal includes the steps of:
extracting satellite television signal expected location data for the received satellite television signal;
obtaining actual satellite television signal location data for the received satellite television signal; and
comparing the extracted satellite television signal location data for the received satellite television signal to the obtained actual satellite television signal location data for the received satellite television signal.

3. The method of claim 2, wherein the step of obtaining actual satellite television signal location data for the received satellite television signal includes the step of:
obtaining actual satellite television signal location data comprising down converted frequency and transponder number of the received satellite television signal.

4. The method of claim 3, wherein the step of comparing the extracted satellite television signal data for the received satellite television signal to the obtain actual satellite television signal data for the received satellite television signal includes the step of:
determining if any one of a first, second and third relationship is valid, where the first relationship comprises actual satellite number of the received satellite television signal equals a predetermined number that is greater than a highest possible transponder number minus an expected transponder number of the received satellite television signal, the second relationship comprises down converted frequency of the received satellite television signal equals a predetermined frequency minus a down converted frequency where the received satellite television signal is located, and the third relationship comprises down converted frequency where the received satellite television signal is located equals a predetermined frequency minus down converted frequency of the received satellite television signal.

5. The method of claim 1, further comprising the step of determining if the received satellite television signal is a proper satellite television signal.

6. A satellite television signal receiver comprising:
means for receiving satellite television signals, said satellite television signals including data indicating expected location of a particular satellite television signal within a frequency band of a frequency spectrum;
means for determining whether actual location data of said particular satellite television signal correlates to said expected location data of said particular satellite television signal; and
means for adjusting said satellite television signal receiver to properly receive said satellite television signals when it is determined that actual position data of said particular satellite television signal is outside correlation to said expected location data.

7. The satellite television signal receiver of claim 6, wherein said means for determining (51) includes:
means for extracting expected satellite television signal location data for the received satellite television signal;
means for obtaining actual satellite television signal location data for the received satellite television signal; and
means for comparing the extracted expected satellite television signal location data for the received satellite television signal to the obtained actual satellite television signal location data for the received satellite television signal.

8. The satellite television signal receiver of claim 7, wherein said means for obtaining actual satellite television signal location data for the received satellite television signal includes means for obtaining actual satellite television signal location data comprising down converted frequency and transponder number of the received satellite television signal.

9. The satellite television signal receiver of claim 8, wherein said means for comparing the extracted expected satellite television signal location data for the received satellite television signal to the obtained actual satellite television signal location data for the received satellite television signal includes means for determining if any one of a first, second and third relationship is valid, where the first relationship comprises actual transponder number of the received satellite television signal equals a predetermined number that is greater than a highest possible transponder number minus an expected transponder number of the received satellite television signal, the second relationship comprises down converted frequency of the received satellite television signal equals a predetermined frequency minus a down converted frequency where the received satellite television signal is located, and the third relationship comprises down converted frequency where the received satellite television signal is located equals a predetermined frequency minus down converted frequency of the received satellite television signal.

10. The satellite television signal receiver of claim 9, further comprising means for determining if the satellite television signal is a proper satellite television signal.

11. A satellite television signal receiver comprising:
a tuner for receiving satellite television signals, said satellite television signals including data indicating expected location of a particular satellite television signal within a frequency band of a frequency spectrum;
determination logic operative to determine whether actual location data of said particular satellite television signal correlates to said expected location data of said particular satellite television signal; and
adjustment logic operative to adjust said satellite television signal receiver to properly receive said satellite television signals when it is determined that actual position data of said particular satellite television signal is outside correlation to said expected location data.

12. The satellite television signal receiver of claim 11, wherein said determination logic (51) includes:
extraction logic for extracting expected satellite television signal location data for the received satellite television signal (54);
acquisition logic for obtaining actual satellite television signal location data for the received satellite television signal (56); and
comparison logic for comparing the extracted expected satellite television signal location data for the received satellite television signal to the obtained actual satellite television signal location data for the received satellite television signal.

13. The satellite television signal receiver of claim 12, wherein said acquisition logic is operative to obtain actual satellite television signal location data comprising down converted frequency and transponder number of the received satellite television signal.

14. The satellite television signal receiver of claim 13, wherein said comparison logic is operative to determine if any one of a first, second and third relationship is valid, where the first relationship comprises actual transponder number of the received satellite television signal equals a predetermined number that is greater than a highest possible transponder number minus an expected transponder number of the received satellite television signal, the second relationship comprises down converted frequency of the received satellite television signal equals a predetermined frequency minus a down converted frequency where the received satellite television signal is located, and the third relationship comprises down converted frequency where the received satellite television signal is located equals a predetermined frequency minus down converted frequency of the received satellite television signal.

15. The satellite television signal receiver of claim 10, further comprising signal processing logic for determining if the satellite television signal is a proper satellite television signal.
